(19) United States
(12) Patent Application Publication
(10) Pub. No.: US 2008/0317226 A1
(43) Pub. Date: Dec. 25, 2008

(54) HANDHELD DEVICE FOR TRANSMITTING A VISUAL FORMAT MESSAGE

(75) Inventors: Michael W. CRUESS, Round Rock, TX (US); Christopher C. YASKO, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/203,480

(22) Filed: Sep. 3, 2008

Related U.S. Application Data
(63) Continuation-in-part of application No. 11/621,487, filed on Jan. 9, 2007.

(51) Int. Cl. H04M 11/00

(52) U.S. Cl. 379/93.17

(57) ABSTRACT

A handset has a receiver that receives a voice message from an operator of the handset. An identification circuit identifies a portion of the voice message that occurs between a first point in time and a second point in time during the voice message. An audio processing circuit converts the portion of the voice information to visual information in a visual format. A transmitter transmits the visual information to a recipient. This allows the recipient to receive particularly specified information in a manner that is convenient to recover and use. A telephone number, for example, may be received as a viewable number and utilized accordingly.

### BACKGROUND

1. Field

This disclosure relates generally to handheld devices, and more specifically, to a handheld device for transmitting a visual format message.

2. Related Art

Traditional handheld devices, such as cellular handsets are used to make phone calls. As part of these phone calls, specific information, such as the caller's phone number, the location of his office, and other types of information is provided to the called party. In many instances, the called party cannot record this information. For example, the called party may be driving a vehicle or may be at a location where the called party does not have access to any paper and pen.

In addition, the caller may be pressed for time and may not have the time to provide detailed information, such as directions to his office or home. In such instances, the called party may have to perform additional processing on their end to generate the additional detailed information, including for example, generating a map corresponding to the location of the caller's office or home.

Accordingly, there is a need for transmitting a visual message in real time.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 shows an exemplary diagram of a system environment, consistent with embodiments of the invention;

FIG. 2 shows exemplary components of a handheld device, consistent with embodiments of the invention;

FIG. 3 shows a flowchart for an exemplary method for dialing a telephone number, consistent with embodiments of the invention;

FIG. 4 shows another flowchart for another exemplary method for dialing a telephone number, consistent with embodiments of the invention;

FIG. 5 shows exemplary components of a handheld device, consistent with embodiments of the invention;

FIG. 6 shows a flowchart for an exemplary method for transmitting a visual format message, consistent with embodiments of the invention; and

FIG. 7 shows exemplary visual format messages, consistent with embodiments of the invention.

### DETAILED DESCRIPTION

In one aspect, a method of operating a handset for receiving voice information from an operator of the handset and transmitting the voice information to a recipient is provided. The method includes identifying a first portion of the voice information received between a first point in time and a second point in time. The method further includes converting the first portion of the voice information to visual information in a visual format. The method further includes transmitting the visual information to the recipient.

In another aspect, a handset comprising a means for receiving a voice message from an operator of the handset is provided. The handset further comprises identification means for identifying a portion of the voice message that occurs between a first point in time and a second point in time during the voice message. The handset further comprises an audio processing circuit that converts the portion of the voice information to visual information in a visual format. The handset further comprises a transmitter that transmits the visual information to a recipient.

In yet another aspect, a handset including means for receiving a voice message from an operator of the handset is provided. The handset further includes a keypad that identifies a first point in time and a subsequent second point in time during the voice message as determined by inputs by the operator to the keypad, wherein a portion of the voice message occurs between the first and second points in time comprises a number. The handset further includes an audio processing circuit that converts the portion of the voice information to numeric information in a visual format. The handset further includes a transmitter that wirelessly transmits the numeric information.

FIG. 1 shows an exemplary diagram of a system environment, consistent with embodiments of the invention. Various handheld devices, such as 12 may be interconnected via network 10. By way of example, network 10 may be a communications network capable of facilitating communication between handheld devices 12. Network 10 may be a wireless network or a combination of wireless and wired networks. Network 10 may include components, such as switching stations and base stations to enable wireless communication between handheld devices 12 and 14. Network components may include hardware and software modules to enable user applications, such as voicemail, data streaming, video streaming, text messaging, and/or other applications.

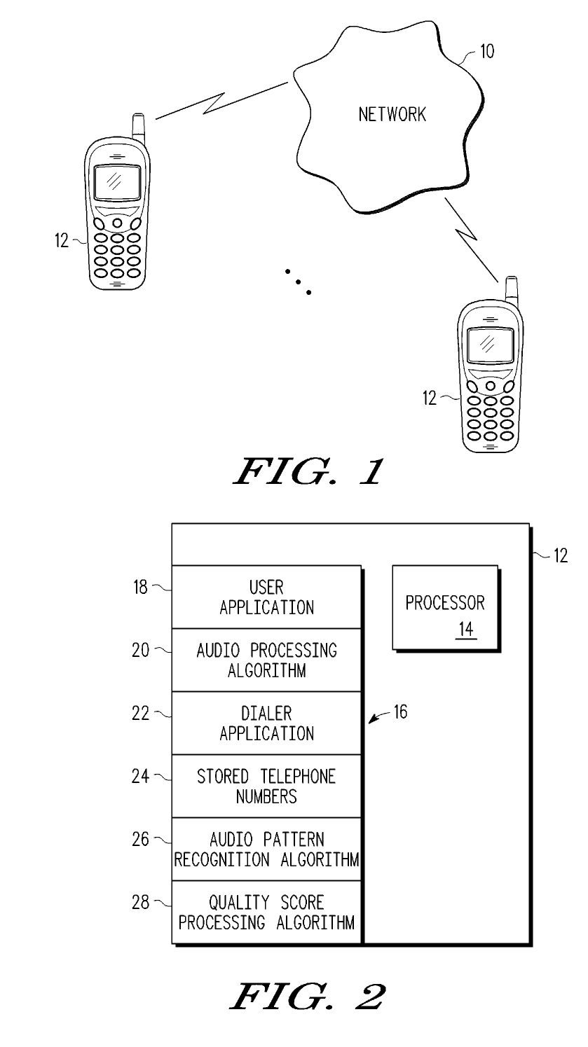

FIG. 2 shows exemplary components of handheld device 12, consistent with embodiments of the invention. Handheld device 12 may be a mobile phone, a PDA, or any other handheld device capable of communicating with network 10. Moreover, handheld device 12 may not be strictly a device held by a user, but could be worn by the user. By way of example, handheld device may include a processor 14 and memory 16. Memory 16 may include various software modules and data to provide different functions associated with handheld device 12. For example, memory 16 may include user application 18, audio processing algorithm 20, dialer application 22, stored telephone numbers 24, audio pattern recognition algorithm 26, and quality score processing algorithm 28. User application 18 may provide a user interface for handheld device 12, such that the user of handheld device 12 may interact with the device. Audio processing algorithm 20 may process audio samples to extract digits corresponding to a telephone number, for example. Dialer application 22 may dial a telephone number. Stored telephone numbers 24 may include telephone numbers stored in memory 16, as part of the user's address book, for example, or on a removable memory SIM card, for example. Audio pattern recognition algorithm 26 may perform matching of extracted digits with stored values. Quality score processing algorithm 28 may determine a quality score corresponding to the extracted digits, for example. Although FIG. 2 shows separate software modules for providing various functions, these modules may be combined or distributed in any manner. Moreover, although FIG. 2 shows only one processor and one memory, handheld device 12 may include other processors and memories. In addition, handheld device 12 may include other hardware, such as a base-band processor, a radio frequency module, an audio processor, and/or a video processor. Furthermore, although FIG. 2 shows specific software modules, there may be additional or fewer software modules. In addition, the functionality of these modules may be combined or distributed in any manner.

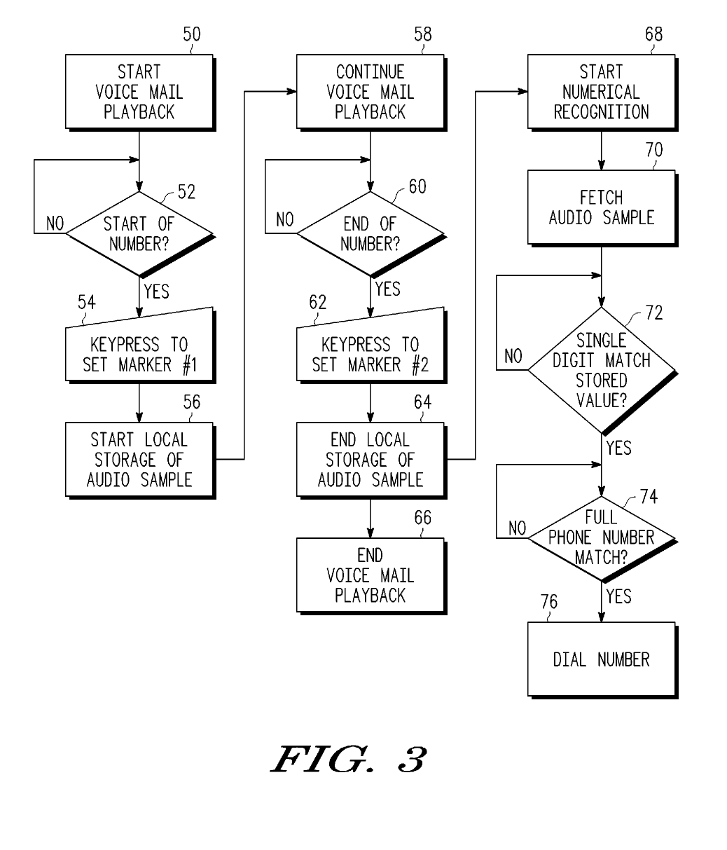

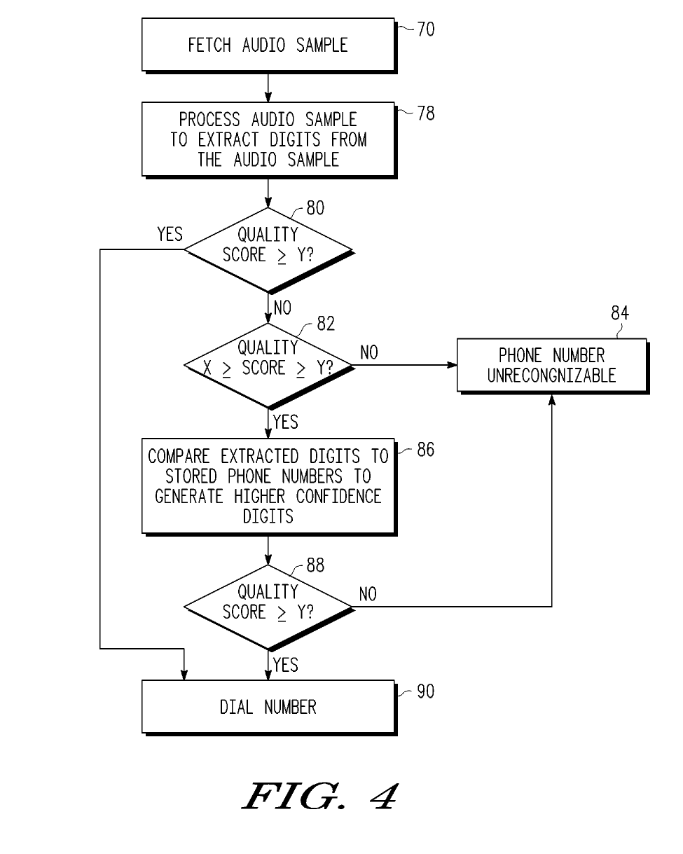

FIG. 3 shows a flowchart for an exemplary method for dialing a telephone number, consistent with embodiments of the invention. A handheld device may process a telephone number embedded in a voicemail received by a user of the handheld device. The handheld device may start playing back the voicemail (step 50). As used herein the term “voicemail” includes a locally stored message, a streamed audio stream containing the message, or any real-time streamed message. Moreover, the term “playing” includes processing the voicemail, such that the user of the handheld device can hear the content of the voicemail. This step may be performed in response to a user input consistent with traditional methods of accessing voicemail. As the voicemail is played back, the user waits for a start of the telephone number (step 52). The telephone number left by the caller may be a mobile phone number, an office phone number, or a home phone number for example, in a traditional 10 digit format (321) 321-4321, or international format (+12) 34 56 78 90, or in an other example in an Internet SIP format 123.123.123.123. Indeed, no telephone number may have been left by the caller. In that instance, other conventional techniques may be used to dial the caller's number.

In response to receiving a first marker set by the user to indicate a start of a telephone number, processor 14 may initiate storage of an audio sample corresponding to the telephone number in memory 16. Audio processing algorithm 20, when executed by processor 14, may perform this step. By way of example, as shown in FIG. 3, the user of handheld device 12 may press a key of handheld device 12. This keypress would result in setting of marker #1 (step 54). For example, the played back voicemail may state: “This is John; I'm at work so call me back at 789-123-4567 later today.” The user may press the key as soon as the user hears the word at, just prior to the start of the telephone number. In response to which local storage of an audio sample would be started by processor 14 of handheld device 12 (step 56). Processor 14 will continue playing back the voicemail (58) until the end of the telephone number is reached (step 60). The user of the handheld device would be listening to the played back voicemail and would be able to tell when the end of the telephone number has been reached.

The method further includes, in response to receiving a second marker set by the user to indicate an end of the telephone number, terminating storage of the audio sample corresponding to the telephone number in the memory. Audio processing algorithm 20, when executed by processor 14, may perform this step. By way of example, as shown in FIG. 3, the user of handheld device 12 may press a key of handheld device 12. This keypress would result in setting of marker #2 (step 62). With reference to the earlier example of the voicemail above, the user may press the key as soon as the user hears the last digit of the played back telephone number. In response to which local storage of an audio sample would be ended by processor 14 of handheld device 12 (step 64). Processor 14 will end voicemail playback (step 66) once the voicemail is played to completion or the user interrupts the playback. Although FIG. 3 specifically shows the setting of marker #2 by the user, the user may not need to set marker #2. In that case, after an elapse of a predetermined time, local storage of the audio sample may be terminated by processor 14. Alternatively, processor 14 may determine an ending of recorded telephone number and terminate local storage of the audio sample. Thus, for example, audio processing algorithm 20 when executed by processor 14 may perform this step automatically without any user action.

The stored audio sample may be processed to extract digits corresponding to the telephone number. Audio pattern recognition algorithm 26, when executed by processor 14, may perform this step. For example, as shown in FIG. 3, audio pattern recognition algorithm 26 may start numerical recognition (step 68). Numerical algorithm processing algorithm 26 may be a voice recognition program that is tuned to match voice prints. To improve performance of audio pattern recognition algorithm 26, a user may train the algorithm to recognize ten digits: 0, 1, 2, 3, 4, 5, 6, 7, 8, and 9, when spoken by the user. Values generated as part of training may be stored in memory 14 of handheld device 12. As part of this process, audio pattern recognition algorithm 26 may fetch audio sample (step 70) and extract digits from it. Audio pattern recognition algorithm 26 may determine whether a single digit (for example, the first digit) matches a stored value (step 72). Audio pattern recognition algorithm 26 may compare a subset of the audio sample (for example, a single digit) to each of the possible stored digits (for example, the digits 1, 2, 3, 4, 5, 6, 7, 8, and 9) and determine a pattern match. Audio pattern recognition algorithm 26 may include repetitive, or recursive steps, to process a single digit. Audio pattern recognition algorithm 26 may include repetitive, or recursive steps, to process each subsequent digit in the stored sample. Audio pattern recognition algorithm 26 may determine whether the full phone number matches (step 74) and if so then pass the full phone number to dialer application 22, which may dial the phone number (step 76). Additionally and/or alternatively, audio pattern recognition algorithm 26 may also pass the full phone number to user application 18, which may display the full phone number to the user of handheld device 12. The user may even be prompted to provide user input to determine whether the phone number should be dialed or not.

FIG. 4 shows another flowchart for another exemplary method for dialing a telephone number, consistent with embodiments of the invention. As part of this step an audio sample corresponding to a telephone number may be fetched (step 70). As explained above, with reference to FIG. 3, the stored audio sample may correspond to audio between the two markers set by the user of handheld device 12. The method further includes processing the audio sample to extract digits corresponding to the telephone number (step 78). Next, quality score processing algorithm 28 may process the extracted digits to determine a quality score corresponding to the extracted digits. Audio pattern recognition algorithm 26 may additionally utilize a quality score processing algorithm 28 to determine the best fit for each, or all, possible digit matches. Quality score processing algorithm 28 may calculate a score based on a pattern match for each individual digit, including a set of stored ideal digits, or a set of trained digits. Additionally, the quality score processing algorithm 28 may determine each, or all, digits meet a minimum quality score threshold. If all digits exceed a predetermined minimum quality score threshold, the audio pattern recognition algorithm 26 is terminated successfully with confidence. If all digits, or any digit, fall below a predetermined quality score threshold, the audio pattern recognition algorithm 26 may terminate unsuccessfully.

The method further includes, if the quality score corresponding to the extracted digits is within a predetermined range, for example, above a minimum threshold but below a maximum threshold then comparing the extracted digits to at least one of a set of locally stored telephone numbers and a set of network-stored telephone numbers to generate higher-confidence digits and communicating the higher-confidence digits to an application executing on the processor. Referring still to FIG. 4, quality score processing algorithm 28 may determine whether the quality score is greater than or equal to predetermined higher threshold value, for example “Y” (step 80) and if so, then dialer application 22 may dial the telephone number (step 90). Value Y may be a numerical value, such as 8, or any other value that can be compared. Otherwise, quality score processing algorithm may determine whether the quality score of the extracted digits is greater than or equal to predetermined lower threshold “X”, but less than predetermined higher threshold “Y”. Value X may be a numerical value, such as 5, or any other value that can be compared. If not, quality score processing algorithm may indicate that the phone number is unrecognizable (step 84). Otherwise, quality score processing algorithm may compare the extracted digits to stored telephone numbers 24 to generate higher-confidence digits (step 86). As part of this step, the extracted digits may be compared to locally stored telephone numbers, such as telephone numbers stored as part of an address book in memory 16 of handheld device. Alternatively and/or additionally, the extracted digits may be compared to stored telephone numbers at a remote location, such as a remote storage connected via network 10 to handheld device 12. If, as a result of this step, the higher-confidence digits are determined to have a quality score greater than or equal to Y (step 88), then the telephone number may be dialed (step 90). Otherwise, quality score processing algorithm 28 may indicate that the phone number is unrecognizable (step 84).

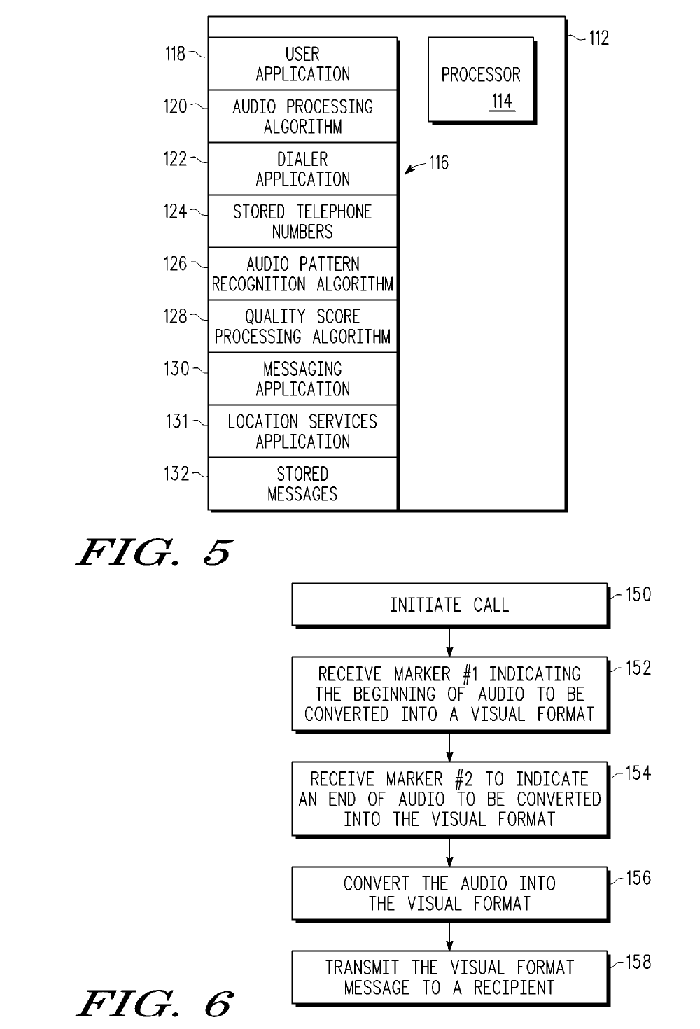

FIG. 5 shows exemplary components of a handheld device 112. Handheld device 112 may be a mobile phone, a PDA, or any other handheld device capable of communicating with network 10. Moreover, handheld device 112 may not be strictly a device held by a user, but could be worn by the user. By way of example, handheld device may include a processor 114 and memory 116. Memory 116 may include various software modules and data to provide different functions associated with handheld device 112. For example, memory 116 may include user application 118, audio processing algorithm 120, dialer application 122, stored telephone numbers 124, audio pattern recognition algorithm 126, quality score processing algorithm 128, messaging application 130, location services application 131, and stored content 132. As described earlier with respect to FIG. 2, user application 118 may provide a user interface for handheld device 112, such that the user of handheld device 112 may interact with the device. Audio processing algorithm 120 may process audio samples to extract information corresponding to a telephone number, address, or any other relevant information, including alphanumeric information. Dialer application 122 may dial a telephone number. Stored telephone numbers 124 may include telephone numbers stored in memory 116, as part of the user's address book, for example, or on a removable memory SIM card, for example. Audio pattern recognition algorithm 126 may perform matching of extracted information with stored values. Quality score processing algorithm 128 may determine a quality score corresponding to the extracted digits, for example. Messaging application 130 may generate a message to be transmitted to a recipient of the message, such as the called party. Location services application 131 may interact with a global positioning system using a GPS device, included as part of handheld device 112, to generate a map corresponding to the location of device 112. Location services application 131 may further generate a map based on a map associated with a telephone number, as well. Stored content 132 may relate to stored messages, images, songs, videos, or other type of digital content. Although FIG. 5 shows separate software modules for providing various functions, these modules may be combined or distributed in any manner. Moreover, although FIG. 5 shows only one processor and one memory, handheld device 112 may include other processors and memories. In addition, handheld device 112 may include other hardware, such as a base-band processor, a radio frequency module, an audio processor, and/or a video processor. Furthermore, although FIG. 5 shows specific software modules, there may be additional or fewer software modules. In addition, the functionality of these modules may be combined or distributed in any manner.

FIG. 6 shows a flowchart for an exemplary method for transmitting a visual format message to a recipient. As an initial step, a user of handheld device 112 may initiate a call (step 150), such as a telephone call to another user, a called party. The call may be initiated in myriad ways, including manually dialing, redialing, voice commands, gestures, or other forms of input to handheld device 112. After the call is initiated, a connection may be established with the called party or a voice response system associated with the called party. Once the connection is established, the caller may begin speaking to either engage the called party in a conversation or to leave a message for the called party. Next, the user (the caller, for example) may identify a first portion of the information received from the caller between a first point in time and a second point in time. In one embodiment, the caller may accomplish this by indicating a beginning of the audio to be converted into a visual format and by indicating an end of the audio to be converted into the visual format, as shown with respect to steps 152 and 154, respectively. As used herein, the term “visual format” includes any message format that can be processed by a called party by viewing a display screen, for example. Exemplary information that could be presented in the visual format, includes, but is not limited to, a text message, a spreadsheet, a photograph, a street map, a tillable form (e.g., a voting form), or any other information that could be processed by the called party by viewing the display screen. In one example, the caller may identify the first and second points in time by using a keypad or another user interface associated with handheld device 112.

In response to receiving a first marker set by the user to indicating the beginning of audio to be converted into a visual format, processor 114 may work with the audio processing application 120 to either begin conversion of the audio or store the audio for later conversion (step 156). Audio processing algorithm 120, when executed by processor 114, may perform this step. By way of example, as shown in FIG. 3, the user of handheld device 112 may press a key of handheld device 112. This keypress would result in setting of marker #1, as shown in step 54 of FIG. 3. For example, the user may state: “This is John; I'm at work so call me back at 789-123-4567 later today.” The user may press the key as soon as the user hears the telephone number or just prior to the start of the telephone number. In response to which local storage of an audio sample would be started by processor 114 of handheld device 112, like step 56 of FIG. 3. Alternatively and/or additionally, the audio sample may be converted into text or some other suitable form in real time. The user may then press the same key or another key to indicate an end of the audio to be converted into the visual format. The visual information may then be transmitted to a recipient of the information (step 158), the called party, for example.

As used herein the term “converting” refers to not only the conversion of audio into text, but also may include the generating of a message that includes the text and other information, such as information that might have been stored as part of stored messages 132 in memory 116. Thus, during the “converting” step, messaging application 130 may be invoked to generate visual information to be transmitted to the recipient. Messaging application 130, when executed by processor 114, or another processor, may perform tasks, such as formatting the visual information in the visual format compatible with appropriate formats that may be readable by the device associated with the recipient's device.

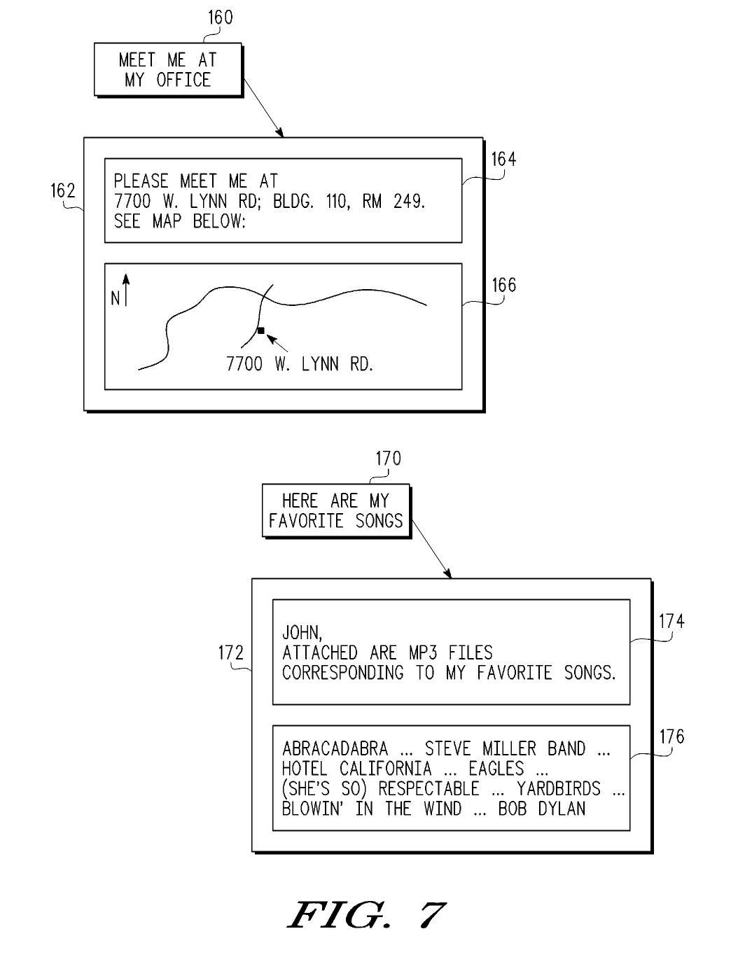

FIG. 7 shows exemplary messages, consistent with embodiments of the invention. An audio sample 160 may contain a message from a caller that states: “MEET ME AT MY OFFICE.” Consistent with step 156, this audio sample may be converted into visual information 162 for transmission to the called party or another recipient of the information. By way of example, visual information 162 may include additional information beyond what was contained in the original message from the caller. Thus, for example, messaging application 130 may process the original message and augment the original message with additional information. In one example, “MEET ME AT MY OFFICE” may be expanded to “PLEASE MEET ME AT 7700 W. LYNN RD; BLDG. 110, RM 249. SEE MAP BELOW,” as shown in portion 164 of visual information 162. The additional information may be retrieved from stored message 132 or other content that may be stored in the storage associated with handheld device 112 or accessed by handheld device 112. As shown in FIG. 7, the additional information may further include a map portion 166. FIG. 7 is merely exemplary and additional information that can be visually presented may also be added.

Referring still to FIG. 7, visual information 170 is another example of converted audio message. As an example, the original message 170 may state “HERE ARE MY FAVORITE SONGS.” Messaging application 130 may process the original message and augment the original message with additional information. Thus, the original message “HERE ARE MY FAVORITE SONGS” may be converted into visual format message 172, including portions 174 and 176. Portion 174 may include additional information, stating, for example “JOHN, ATTACHED ARE MP3 FILES CORRESPONDING TO MY FAVORITE SONGS.” In this manner, messaging application 130 may automatically add the name of the person to whom the message is addressed. Messaging application 130 may further augment the message by specifying the type/format of the files. In this example, messaging application 130 may indicate that the favorite songs are in MP3 format. Portion 176 may include a list of the favorite songs, for example. Additional information may also be added. The extent of additional information added may be programmed as part of the user configuration of handheld device 112 and messaging application 130.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method of operating a handset for receiving voice information from an operator of the handset and transmitting the voice information to a recipient, comprising:
identifying a first portion of the voice information received between a first point in time and a second point in time;
converting the first portion of the voice information to visual information in a visual format; and
transmitting the visual information to the recipient.

2. The method of claim 1, wherein the step of identifying is further characterized by the first and second points in time being identified through a keypad of the handset.

3. The method of claim 1, wherein the step of identifying is further characterized by the first portion of the voice information comprising alphanumeric information.

4. The method of claim 3, wherein the step of identifying is further characterized by the first portion of the voice information comprising a telephone number.

5. The method of claim 4, wherein the step of converting is further characterized by performing direct voice recognition from the first portion of the voice information to the visual information, wherein the visual information comprises the telephone number in the visual format.

6. The method of claim 1, wherein the step of converting is further characterized by using the first portion of the voice information to select a message stored in the handset prior to receiving the voice information.

7. The method of claim 6, wherein the step of converting is further characterized by the message comprising one of a plurality of stored introduction messages and a one of plurality of stored modifiable documents.

8. The method of claim 1, wherein the step of converting is further characterized as comprising storing the first portion of the voice message between the first and second points in time.

9. A handset, comprising:
means for receiving a voice message from an operator of the handset;
identification means for identifying a portion of the voice message that occurs between a first point in time and a second point in time during the voice message;
an audio processing circuit that converts the portion of the voice information to visual information in a visual format; and
a transmitter that transmits the visual information to a recipient.

10. The handset of claim 9, further comprising a keyboard coupled to the identification means.

11. The handset of claim 10, wherein the identification means is further characterized as receiving information identifying the first and second points in time from the keypad.

12. The handset of claim 9, further comprising storage means, coupled to the audio processing circuit, for storing the portion of the voice message.

13. The handset of claim 9, wherein the visual information is a direct voice recognition of the first portion of the message.

14. The handset of claim 13, wherein the first portion of the message comprises alphanumeric information.

15. The handset of claim 14, wherein the alphanumeric information comprises a telephone number.

16. The handset of claim 9, further comprising a stored messages circuit coupled to the audio processing circuit.

17. The handset of claim 16, wherein the audio processing circuit responds to the first portion of the voice message by selecting a message stored in the stored messages circuit.

18. A handset, comprising
means for receiving a voice message from an operator of the handset;
a keypad that identifies a first point in time and a subsequent second point in time during the voice message as determined by inputs by the operator to the keypad, wherein a portion of the voice message occurs between the first and second points in time comprises a number;
an audio processing circuit that converts the portion of the voice information to numeric information in a visual format; and
a transmitter that wirelessly transmits the numeric information.

19. The handset of claim 18, further comprising a storage circuit that stores the first portion of the voice message.

20. The handset of claim 19, wherein the numeric information comprises a telephone number.
